(19) United States
(12) Patent Application Publication
(10) Pub. No.: US 2005/0148264 A1
(43) Pub. Date: Jul. 7, 2005

(54) Bimodal pore size nonwoven web and wiper

(76) Inventors: Eugenio Go Varona, Marietta, GA (US); Alan Edward Wright, Woodstock, GA (US)

Correspondence Address: KIMBERLY-CLARK WORLDWIDE, INC., 401 NORTH LAKE STREET, NEENAH, WI, 54956, US

(21) Appl. No.: 10/748,648

(22) Filed: Dec. 30, 2003

(51) Int. Cl. B29D 23/00; B29D 22/00; B32B 1/00; D04H 3/00; D04H 13/00; B32B 5/06; D04H 1/46; D04H 3/10; B32B 5/02; F16L 1/00

(52) U.S. Cl. 442/382; 442/381; 442/59; 442/401; 442/387; 442/408; 428/137; 428/220; 428/35.9; 428/36.1; 428/36.5

(57) ABSTRACT

The present invention provides a nonwoven web laminate having at least a bimodal pore size distribution. The laminate has a first layer with pores having a mean equivalent pore radius greater than about 100 μm and a second layer with pores having a mean equivalent pore radius less than about 100 μm. Generally, the first layer has a mean equivalent pore size radius in the range of about 1 μm to about 100 μm and the second layer has a mean equivalent pore size radius in the range of about 100 μm to about 1000 μm. The layer having an average pore size radius greater than 100 μm provides rapid fluid release from the laminate to facilitate cleaning by providing a cleaning solution to solubilize particles or viscous liquids on the surface. In addition, the large pore size allows particles and viscous liquids to be captured and trapped within the pores of the laminate, thereby effectively cleaning the surface to be cleaned. The layer with the small pore size provides a fluid reservoir function by absorbing fluid and holding the fluid in the laminate, or by holding a cleaning fluid to be released during a cleaning operation. The nonwoven web laminate of the present invention is an effective wiper.

### FIELD OF THE INVENTION

The present invention relates to a nonwoven web laminate having at least a bimodal pore size distribution. More specifically, the present invention relates to a wipe or wiper prepared from the nonwoven web laminate having at least a bimodal pore size distribution.

### BACKGROUND OF THE INVENTION

Nonwoven fabrics or webs are useful for a wide variety of applications such as diapers, feminine hygiene products, towels, wipers, recreational or protective fabrics and as geotextiles and filter media. The nonwoven webs used in these applications may be simply spunbond fabrics, but are often in the form of nonwoven fabric laminates like spunbond/spunbond laminates or spunbond/meltblown/spunbond (SMS) laminates. Laminates with other materials are also possible, such as with films and paper.

Saturated or pre-moistened paper and textile wipers have been used in a variety of wiping and polishing cloths. These substrates are often provided in a sealed container and retrieved therefrom in a moist or saturated condition (i.e. pre-moistened). The pre-moistened cloth or paper wiper releases the retained liquid when used to clean or polish the desired surface. In addition, meltblown fiber fabrics have also been used as pre-moistened wipers in various applications and end uses. It is known that meltblown fiber fabrics are capable of receiving and retaining liquids for extended periods of time. More particularly, meltblown fiber fabrics are capable of being supplied in a stacked or rolled form wherein, when saturated with a liquid, the meltblown fiber fabrics maintain the liquid uniformly distributed throughout the stack. Thus, meltblown fiber sheets can be stacked in a sealable container and liquid added thereto. The sealed container can then be stored or shipped as needed and the stacked meltblown fabric retains the liquid evenly throughout the stack during the shelf life of the product. Uniformly moist meltblown fiber fabrics provided in a stacked form are described in U.S. Pat. Nos. 4,853,281 and 4,833,033, both to Win et al. Pre-moistened meltblown fiber fabrics have found a wide variety of applications including use as polishing clothes, hand wipes, hard surface cleaners and so forth. By way of example, various applications of pre-saturated meltblown fabrics are described in U.S. Pat. No. 5,656,361 to Vogt et al. U.S. Pat. No. 5,595,786 to McBride et al. and U.S. Pat. No. 5,683,971 to Rose et al.

While meltblown fabrics provide desirable liquid absorption and retention characteristics, meltblown fabrics also provide a metered release of the liquid retained from the meltblown. Meltblown nonwoven webs are also not effective in trapping and removing particles of different sizes or viscous liquids, such as mixtures and emulsions, thereby removing particles and viscous liquids from the surface being cleaned.

Multilayer laminates comprising spunbond fiber nonwoven webs and meltblown fiber fabrics have been previously utilized in order to provide a wiper that exhibits less linting and improved durability. However, although meltblown fabrics exhibit good liquid absorption and retention characteristics, these characteristics have not heretofore been readily achievable with spunbond fiber nonwoven webs. Thus, the meltblown fiber webs provide such laminates with good liquid retention characteristics and the outer spunbond fabric provide reduced linting. As an example, U.S. Pat. No. 4,436,780 to Hotchkiss et al. describes a spunbond/meltblown/spunbond laminate having a relatively high basis weight meltblown layer between two spunbond fiber layers. Other multilayer laminate wipers are described in, for example, U.S. Pat. No. 4,906,513 to Kebbell et al., which describes a wiper having a central absorbency layer with two continuous filament layers on either side of the absorbency layer. The layers of the '513 patent are pattern bonded together. The laminates of these patents are also not effective in trapping and removing particles of different sizes or viscous liquids, such as mixtures and emulsions, thereby removing particles and viscous liquids from the surface being cleaned.

Thus, there exists a need for a wiper which can effectively remove particles and viscous liquids from a surface to be cleaned but still be able to supply cleaning fluid on demand.

### SUMMARY OF THE INVENTION

The present invention provides a nonwoven web laminate having at least a bimodal pore size distribution. The laminate has a first layer with pores having a mean equivalent pore radius greater than about 100 μm and a second layer with pores having a mean equivalent pore radius less than about 100 μm. Generally, the first layer has a mean equivalent pore size radius in the range of about 1 μm to about 100 μm and the second layer has a mean equivalent pore size radius in the range of about 100 μm to about 1000 μm. The layer having an average pore size radius greater than 100 μm provides rapid fluid release and/or fluid release under low wiping pressures from the laminate to facilitate cleaning by providing a cleaning solution to solubilize particles or viscous liquids on the surface. In addition, the large pore size allows particles and viscous liquids to be captured and trapped within the pores of the laminate, thereby effectively cleaning the surface to be cleaned. The layer with the small pore size provides a fluid reservoir function by absorbing fluid and holding the fluid in the laminate, or by holding a cleaning fluid to be released during a cleaning operation. The cleaning fluid can be released from the layer of the laminate having a mean equivalent radius less than 100 μm under higher wiping pressures.

In another aspect of the present invention, the laminate may be a three or more layer structure. For example, if the laminate is a three layer structure, the outer layers may each be a layer of the nonwoven with a mean equivalent radius greater than 100 μm and the inner layer having a mean equivalent pore radius of less than 100 μm. In this configuration, the large pores on the outer layer of the laminate serve to capture dirt, particle and viscous fluids. In addition, the outer layers may both be layers with a mean equivalent radius less than 100 μm with the middle layer having a mean equivalent radius greater that 100 μm. In this configuration, the large pore layer is able to release any cleaning fluid on demand.

The nonwoven web laminate of the present invention is useful in a variety of applications, including dry wiper, premoistened wipes, filter applications and any other application where it is necessary or desirable to trap or capture particles.

### BRIEF DESCRIPTION OF THE DRAWINGS

FIG. 1 shows a two-layer nonwoven web laminate of the present invention.

FIG. 2 shows a three-layer laminate of the present invention.

FIG. 3 shows the equivalent pore radius of each layer of the laminate produced in the Examples.

### DEFINITIONS

As used herein, the term “comprising” is inclusive or open-ended and does not exclude additional unrecited elements, compositional components, or method steps.

As used herein, the term “consisting essentially of” does not exclude the presence of additional materials which do not significantly affect the desired characteristics of a given composition or product. Exemplary materials of this sort would include, without limitation, pigments, antioxidants, stabilizers, surfactants, waxes, flow promoters, particulates and materials added to enhance processability of the composition.

As used herein, the term “fiber” includes both staple fibers, i.e., fibers which have a defined length between about 19 mm and about 60 mm, fibers longer than staple fiber but are not continuous, and continuous fibers, which are sometimes called “substantially continuous filaments” or simply “filaments”. The method in which the fiber is prepared will determine if the fiber is a staple fiber or a continuous filament.

As used herein, the term “microfibers” means small diameter fibers having an average diameter not greater than about 100 microns, for example, having an average diameter of from about 0.5 microns to about 60 microns, or more particularly, microfibers may have an average diameter of from about 4 microns to about 40 microns.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters useful are usually expressed in microns, or in the case of staple fibers, denier. It is noted that to convert from osy to gsm, multiply osy by 33.91.

As used herein, the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin, which is hereby incorporated by reference in its entirety. Meltblown fibers are microfibers, which may be continuous or discontinuous, and are generally smaller than 10 microns in average diameter. The term “meltblown” is also intended to cover other processes in which a high velocity gas, (usually air) is used to aid in the formation of the filaments, such as melt spraying or centrifugal spinning.

As used herein the term “spunbond fibers” refers to small diameter fibers of molecularly oriented polymeric material. Spunbond fibers may be formed by extruding molten thermoplastic material as filaments from a plurality of fine, usually circular capillaries of a spinneret with the diameter of the extruded filaments then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

“Airlaying” or “airlaid” is a well known process by which a fibrous nonwoven layer can be formed. In the airlaying process, bundles of small fibers having typical lengths ranging from about 3 to about 19 millimeters (mm) are separated and entrained in an air supply and then deposited onto a forming screen, usually with the assistance of a vacuum supply. The randomly deposited fibers then are bonded to one another using, for example, hot air or a spray adhesive.

As used herein, the term “coform nonwoven web” or “coform material” means composite materials comprising a mixture or stabilized matrix of thermoplastic filaments and at least one additional material, usually called the “second material” or the “secondary material”. As an example, coform materials may be made by a process in which at least one meltblown die head is arranged near a chute through which the second material is added to the web while it is forming. The second material may be, for example, an absorbent material such as fibrous organic materials such as woody and non-wood cellulosic fibers, including regenerated fibers such as cotton, rayon, recycled paper, pulp fluff; superabsorbent materials such as superabsorbent particles and fibers; inorganic absorbent materials and treated polymeric staple fibers and the like; or a non-absorbent material, such as non-absorbent staple fibers or non-absorbent particles. Exemplary coform materials are disclosed in commonly assigned U.S. Pat. No. 5,350,624 to Georger et al.; U.S. Pat. No. 4,100,324 to Anderson et al.; and U.S. Pat. No. 4,818,464 to Lau et al.; the entire contents of each is hereby incorporated by reference.

“Bonded carded web” refers to webs that are made from staple fibers which are sent through a combing or carding unit, which separates or breaks apart and aligns the staple fibers in the machine direction to form a generally machine direction-oriented fibrous nonwoven web. Such fibers are usually purchased in bales which are placed in an opener/blender or picker which separates the fibers prior to the carding unit. Once the web is formed, it then is bonded by one or more of several known bonding methods. One such bonding method is powder bonding, wherein a powdered adhesive is distributed through the web and then activated, usually by heating the web and adhesive with hot air. Another suitable bonding method is pattern bonding, wherein heated calender rolls or ultrasonic bonding equipment are used to bond the fibers together, usually in a localized bond pattern, though the web can be bonded across its entire surface if so desired. Another suitable and well-known bonding method, particularly when using bicomponent staple fibers, is through-air bonding.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

As used herein, the term “pattern bonded” refers to a process of bonding a nonwoven web in a pattern by the application of heat and pressure or other methods, such as ultrasonic bonding. Thermal pattern bonding typically is carried out at a temperature in a range of from about 80° C. to about 180° C. and a pressure in a range of from about 150 to about 1,000 pounds per linear inch (59-178 kg/cm). The pattern employed typically will have from about 10 to about 250 bonds/inch² (1-40 bonds/cm²) covering from about 5 to about 30 percent of the surface area. Such pattern bonding is accomplished in accordance with known procedures. See, for example, U.S. Design Pat. No. 239,566 to Vogt, U.S. Design Pat. No. 264,512 to Rogers, U.S. Pat. No. 3,855,046 to Hansen et al., and U.S. Pat. No. 4,493,868 to Meitner et al. and U.S. Pat. No. 5,858,515 to Stokes et al., for illustrations of bonding patterns and a discussion of bonding procedures, which patents are incorporated herein by reference. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

As used herein, “bimodal pore size distribution” means that there are at least two distinct pore size peaks in the pore size distribution for the overall laminate.

“Permanently creped” refers to a creped nonwoven web having bonded and unbonded areas, in which the bonded areas are permanently bent out-of-plane and the unbonded portions are permanently looped, such that the nonwoven web cannot be returned to its original uncreped state by applying a mechanical stress, such as may be encountered during further processing or use conditions.

“Crepe level” is a measure of creping and is calculated according to the following equation:

$$\text{Crepe level (\%)} = \frac{\begin{matrix}\text{Speed of Creping Surface minus speed} \\ \text{of windup reel for the creped web}\end{matrix}}{\text{Speed of Creping Surface}} \times 100$$

“Bent out-of-plane” refers to a bonding or orientation of portions of the nonwoven web in a direction away from the plane in which the nonwoven web substantially lies before being subjected to the creping process. As used herein, the phrase “bent out-of-plane” generally refers to nonwoven webs having creped portions bent at least about 15 degrees away from the plane of the uncreped nonwoven web, preferably at least about 30 degrees.

“Looped” refers to unbonded filaments or portions of filaments in a creped nonwoven web which define an arch, semi-circle or similar configuration extending above the plane of the uncreped nonwoven web, and terminating at both ends in the nonwoven web (e.g., in the bonded areas of the creped nonwoven web).

### DETAILED DESCRIPTION OF THE INVENTION

The nonwoven web laminate of the present invention is a multilayer laminate having at least two nonwoven webs. At least one nonwoven web of the laminate has a mean equivalent pore size radius of at least 100 μm and at least one nonwoven web of the laminate has a mean equivalent pore size radius of less than 100 μm. In addition to each web having the specified mean equivalent pore size radius, the overall laminate needs to have a pore size distribution which is at least bimodal. Each nonwoven web of the laminate provides unique properties to the laminate.

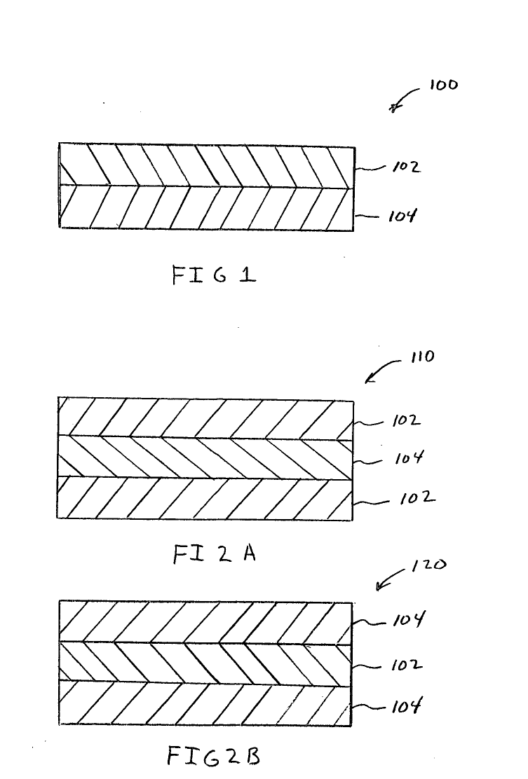

In order to obtain a better understanding of the laminate of the present invention, FIG. 1 shows a two-layer nonwoven web laminate 100. A first layer 102 is adjacent to a second layer 104 are bonded together using a bonding method described below. At least one of the first layer and second layer has a mean equivalent pore size radius of at least 100 μm and at least one of the first layer and the second layer has a mean equivalent pore size radius of less than 100 μm. It is pointed out that this is an embodiment of the present and that other embodiments will be described below.

The upper limit for the average pore size radius for the layer having a mean equivalent pore size radius of at least 100 μm should be large enough to capture and hold particles and viscous liquids or mixtures of fluids and particles, such as bowel movements. The upper limit for the mean equivalent pore size for this layer could be as high as 1000 μm. Ideally, the upper limit for the mean equivalent pore size radius should be about 600 μm, and preferably about 400 μm.

The lower limit for the a mean equivalent pore size radius for the layer having a pore size less than 100 μm should be such that the resulting laminate will release fluids on demand, when the laminate is saturated. The lower limit of the mean equivalent pore size radius could be as low as 1 μm. Ideally, the lower limit for the mean equivalent pore size radius should be greater than about 5 μm, and preferably greater than about 20 μm.

The layer having an average pore size radius greater than 100 μm provides rapid fluid release from the laminate to facilitate cleaning by providing a cleaning solution to solubilize particles or viscous liquids on the surface. The cleaning fluid can be released from this layer under low wiping pressures. In addition, the large pore size allows particles and viscous liquids to be captured and trapped within the pores of the laminate, thereby effectively cleaning the surface to be cleaned. When used as a saturated wipe, the layer having a mean equivalent pore size radius of 100 μm or less provides a solution reservoir type function by storing the solution with the pores. This reservoir function allows additional cleaning solution to be released from the laminate on demand by the user, typically by applying more pressure to the wipe, allowing for additional cleaning of the surface after the initial cleaning and removing of particles and/or viscous liquid from the surface to be cleaned.

Any nonwoven web having a mean equivalent pore size radius of at least 100 microns can be used in this layer of the laminate. Exemplary materials include, but are not limited to, creped nonwoven webs, nonwoven webs having fibers with a diameter in excess of about 20 μm, desirable in excess of 24 μm, nonwoven webs having highly crimped fibers, nonwoven webs having high bond-to-bond distances or nonwoven webs having a combination of one or more of these properties. Webs having crimped fibers are described in, for example, U.S. Pat. No. 5,382,400 to Pike et al., which is hereby incorporated by reference. Webs having a high bond-to-bond distances are described can have bond distances in excess of 1 mm apart. Typically, the bond distances for the high bond-to-bond distance nonwoven were in the rage of about 1 to about 20 mm apart, typically between about 1.5 to 10 mm apart and usually between about 2 to about 3 mm apart. An example of high bond-to-bond distance nonwoven web is an expanded Hansen & Penning or “EHP” bond pattern having pin spacing, when new of about 2.5 mm apart. Generally, the nonwoven webs used in the layer having a mean equivalent pore size radius greater than 100 microns are spunbond or bonded carded webs. Other nonwoven webs can be used in this layer; however, of the nonwoven webs mentioned, spunbond and bonded carded web are desired from an economic and performance standpoint. The nonwoven web may also be creped. Creped nonwoven preferably have a creping level in the range of about 1 to about 60%. Ideally, the creping level is desirably about 30% to about 50%. Creped nonwovens useable in this invention include those described in U.S. Pat. No. 6,150,002 to Varona, which is hereby incorporated by reference in its entirety.

Any nonwoven web having a mean equivalent pore size radius less than about 100 microns may be used in this layer of the laminate. Exemplary materials which can be used as the layer having a mean equivalent pore size radius of less than 100 μm include, but are not limited to, pulp based nonwoven webs, coform nonwoven webs, airlaid nonwoven webs, hydroentangled nonwoven webs or a combination of these nonwoven webs. Generally, it is preferred, but not required that a coform nonwoven web be used as this layer.

The coform nonwoven web layer(s) can have from 20-50 wt. % of thermoplastic polymer fibers and 80-50 wt. % of pulp fibers. The preferred ratio of polymer fibers to pulp fibers can be from 25-40 wt. % of polymer fibers and 75-60 wt. % of pulp fibers. A more preferred ratio of polymer fibers to pulp fibers can be from 30-40 wt. % of polymer fibers and 70-60 wt. % of pulp fibers. The most preferred ratio of polymer fibers to pulp fibers can be from 35 wt. % of polymer fibers and 65 wt. % of pulp fibers.

Fibers of diverse natural origin are applicable to the invention. Digested cellulose fibers from softwood (derived from coniferous trees), hardwood (derived from deciduous trees) or cotton linters can be utilized. Fibers from Esparto grass, bagasse, kemp, flax, and other lignaceous and cellulose fiber sources may also be utilized as raw material in the invention. For reasons of cost, ease of manufacture and disposability, preferred fibers are those derived from wood pulp (i.e., cellulose fibers). A commercial example of such a wood pulp material is available from Weyerhaeuser as CF-405. Generally wood pulps can be utilized. Applicable wood pulps include chemical pulps, such as Kraft (i.e., sulfate) and sulfite pulps, as well as mechanical pulps including, for example, groundwood, thermomechanical pulp (i.e., TMP) and chemithermomechanical pulp (i.e., CTMP). Completely bleached, partially bleached and unbleached fibers are useful herein. It may frequently be desired to utilize bleached pulp for its superior brightness and consumer appeal.

Also useful in the present invention are fibers derived from recycled paper, which can contain any or all of the above categories as well as other non-fibrous materials such as fillers and adhesives used to facilitate the original paper making process.

In a further aspect of the present invention, an additional layer having a mean equivalent pore size radius greater than 100 μm may be included in the laminate. When this additional layer is present, it may be laminated to the first two layers such that the additional layer is adjacent to the layer having a mean equivalent pore size radius greater than 100 μm, or may be laminated such that the layer having a mean equivalent pore size radius less than 100 μm is between the two layer having an average pore size radius greater than 100 μm. For a better understanding of this aspect of the present invention, attention is directed to FIG. 2. In FIG. 2A, the nonwoven laminate 110, has three layers, where layer 102 has a mean equivalent pore size radius greater than 100 μm is on either side of the layer 104 having a mean equivalent pore size radius less than 100 μm. In FIG. 2B, the nonwoven laminate 120, has three layers, where layers 104 having a mean equivalent pore size radius less than 100 μm are each adjacent to layer 102 having a mean equivalent pore size radius greater than 100 μm. Other configurations can be used, for example two layers having a mean equivalent pore size radius greater than 100 μm may be adjacent to each other and one of the layers is adjacent to a layer having a mean equivalent pore size radius less than 100 μm. Likewise, two layers having a mean equivalent pore size radius less than 100 μm may be adjacent to each other and one of the layer is adjacent to a layer having a mean equivalent pore size radius greater than 100 μm.

The layers of the multilayer laminate may be generally bonded in some manner as they are produced in order to give them sufficient structural integrity to withstand the rigors of further processing into a finished product and during use as the finished product. Bonding can be accomplished in a number of ways such as hydroentanglement, needling, ultrasonic bonding, adhesive bonding and thermal bonding. Ultrasonic bonding is performed, for example, by passing the multilayer nonwoven web laminate between a sonic horn and anvil roll as illustrated in U.S. Pat. No. 4,374,888 to Bornslaeger, which is hereby incorporated by reference in its entirety.

Thermal bonding of a multilayer laminate may be accomplished by passing the laminate between the rolls of a calendering machine. At least one of the rollers of the calender is heated and at least one of the rollers, not necessarily the same one as the heated one, has a pattern which is imprinted upon the laminate as it passes between the rollers. As the laminate passes between the rollers, the laminate is subjected to pressure as well as heat. The combination of heat and pressure applied in a particular pattern results in the creation of fused bond areas in the multilayer laminate where the bonds thereon correspond to the pattern of bond points on the calender roll.

Various patterns for calender rolls have been developed. One example is the Hansen-Pennings pattern with between about 10 to 25% bond area with about 100 to 500 bonds/square inch as taught in U.S. Pat. No. 3,855,046 to Hansen and Pennings. Another common pattern is a diamond pattern with repeating and slightly offset diamonds. The particular bond pattern can be any pattern known to those skilled in the art. The bond pattern is not critical for imparting the properties to the liner or mat of the present invention.

The exact calender temperature and pressure for bonding the multilayer laminate depend on thermoplastic polymers from which the nonwoven webs and/or film material are made. Generally for multilayer nonwoven web laminates formed from polyolefins, the desired temperatures are between 1500 and 350° F. (660 and 177° C.) and a pressure between 300 and 1000 pounds per linear inch. More particularly, for polypropylene, the desired temperatures are between 270° and 320° F. (132° and 160° C.) and the pressure between 400 and 800 pounds per linear inch. However, the actual temperature and pressures needed are highly dependent of the particular thermoplastic polymers used in each of the layers. The actual temperature and pressure used to bond the layers of the laminate together will be readily apparent to those skilled in the art and would depend on factors such as basis weight and line speed. Of the available method for bonding the layer of the multilayer laminate nonwoven web usable in the present invention, thermal and ultrasonic bonding are preferred due to factors such as materials cost and ease of processing.

Suitable thermoplastic polymers useful for preparing the individual nonwoven layers of the laminate of the present invention include polyolefins, polyesters, polyamides, polycarbonates, polyurethanes, polyvinylchloride, polytetrafluoroethylene, polystyrene, polyethylene terephathalate, biodegradable polymers such as polylactic acid and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof.

Many polyolefins are available for fiber production, for example polyethylenes such as Dow Chemical's ASPUN 6811A linear low-density polyethylene, 2553 LLDPE and 25355 and 12350 high density polyethylene are such suitable polymers. The polyethylenes have melt flow rates in g/10 min. at 190° F. and a load of 2.16 kg, of about 26, 105, 25 and 12, respectively. Fiber forming polypropylenes include, for example, Basell's PF-015 polypropylene. Many other polyolefins are commercially available and generally can be used in the present invention. The particularly preferred polyolefins are polypropylene and polyethylene.

Examples of polyamides and their methods of synthesis may be found in “Polyamide Resins” by Don E. Floyd (Library of Congress Catalog number 66-20811, Reinhold Publishing, N.Y., 1966). Particularly commercially useful polyamides are nylon 6, nylon-6,6, nylon-11 and nylon-12. These polyamides are available from a number of sources such as Custom Resins, Nyltech, among others. In addition, a compatible tackifying resin may be added to the extrudable compositions described above to provide tackified materials that autogenously bond or which require heat for bonding. Any tackifier resin can be used which is compatible with the polymers and can withstand the high processing (e.g., extrusion) temperatures. If the polymer is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ® and ARKON® P series tackifiers are examples of hydrogenated hydrocarbon resins. ZONATAC® 501 Lite is an example of a terpene hydrocarbon. REGALREZ® hydrocarbon resins are available from Hercules Incorporated. ARKON®P series resins are available from Arakawa Chemical (USA) Incorporated. The tackifying resins such as disclosed in U.S. Pat. No. 4,787,699, hereby incorporated by reference, are suitable. Other tackifying resins that are compatible with the other components of the composition and can withstand the high processing temperatures may also be used.

Of these thermoplastic polymers, polyolefins are desirably used. In particular polyethylene and polypropylene are most desirable.

The fibers used in each of the layer may be monocomponent fibers, multicomponent fibers, multiconstituent fibers. In addition, the fibers may be shaped, or round fibers.

The multilayer laminate of the present invention has an overall basis weight, based on the weight of the nonwoven laminate only of from about 0.4 to 10 ounces per square yard (osy) (about 13.6 to 339 grams per square meter (gsm)), or more particularly from about 1.0 to about 7.0 osy (about 34 to about 237 gsm). Most preferably, the basis weight is between about 1.0 and 6.0 osy (about 33.9 to about 203 gsm), since this basis weight has a good balance between thickness and cushioning.

Capillarity of a structure is directly related to the pore size or radius distribution. Capillarity is defined as the propensity of the structure to absorb or hold fluids and is typically expressed as capillary pressure. The mean equivalent average pore radius is measured by a capillary tension method. In this method, capillary tension is based on the LaPlace equation:
Capillary Pressure=2(liquid surface tension×cos(contact angle))/r.

The mean pore radius are measured using an apparatus described further in an article by Burgeni and Kapur, in the Textile Research Journal, Volume 37, pp. 356-366 (1967), the disclosure of which is incorporated by reference. The apparatus includes a movable stage interfaced with a programmable stepper motor, and an electronic balance controlled by a computer. A control program automatically moves the stage to a desired height, collects data at a specified sampling rate until equilibrium is reached, and then moves the stage to the next calculated height. Controllable parameters include sampling rates, criteria for equilibrium and the number of absorption/desorption cycles.

The laminate of the present invention may be produced using an in-line process, a process were both or all layers are produced and laminated in one process, or prepared using an off-line process. In an off-line process, each of the layers is separately produced, rolled and transported to a laminating machine, which laminates the layers together. A combination of an in-line process and an off-line process, where one of the layers is made in-line and another is supplied to the laminating process via a roll.

When used as a wipe, the laminates of the present invention are well suited for a variety of dry and wet cleaning operations such as: mopping floors; cleaning of dry surfaces: cleaning and drying wet surfaces such as counters, tabletops or floors (e.g. wet surfaces resulting from spills); sterilizing and/or disinfecting surfaces by applying liquid disinfectants; wiping down and/or cleaning appliances, machinery or equipment with liquid cleansers; rinsing surfaces or articles with water or other diluents (e.g. to remove cleaners, oils, etc.), removing dirt, dust and/or other debris and so forth. In addition, the laminates of the present inventions have utility in personal care wipes, such as baby wipes, hand wipes or facial wipes. The laminates have numerous uses as a result of its combination of physical attributes, especially the uptake and retention dirt, dust and/or debris. This combination of physical attributes is highly advantageous for cleaning surfaces with or without cleaning liquids such as soap and water or other common household cleaners. Further, the laminates of the present invention are sufficiently low cost to allow disposal after either a single use or a limited number of uses. By providing a disposable wiper, it is possible to avoid problems associated with permanent or multi-use absorbent products such as, for example, cross-contamination and the formation of bad odors, mildew, mold, etc.

The wipers from the laminate of the present invention can be provided dry or pre-moistened. In one aspect, dry cleaning sheets can be provided with solid cleaning or disinfecting agents coated on or in the sheets. In addition, the cleaning sheets can be provided in a pre-moistened condition. The pre-moistened of the present invention contain a wiper from a laminate of the present invention and a liquid which partially or fully saturates the wiper. The wet cleaning sheets can be maintained over time in a sealable container such as, for example, within a bucket with an attachable lid, sealable plastic pouches or bags, canisters, jars, tubs and so forth. Desirably the wet, stacked cleaning sheets are maintained in a resealable container. The use of a resealable container is particularly desirable when using volatile liquid compositions since substantial amounts of liquid can evaporate while using the first sheets thereby leaving the remaining sheets with little or no liquid. Exemplary resealable containers and dispensers include, but are not limited to, those described in U.S. Pat. No. 4,171,047 to Doyle et al., U.S. Pat. No. 4,353,480 to McFadden, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference. The wipers can be incorporated or oriented in the container as desired and/or folded as desired in order to improve ease of use or removal as is known in the art. Such folded configurations are well known to those skilled in the art and include c-folded, z-folded, quarter-folded configurations and the like. The stack of folded wet wipes may be placed in the interior of a container, such as a plastic tub, to provide a package of wet wipes for eventual sale to the consumer. Alternatively, the wet wipes may include a continuous strip of material which has perforations between each wipe and which may be arranged in a stack or wound into a roll for dispensing.

With regard to pre-moistened sheets, a selected amount of liquid is added to the container such that the wipers contain the desired amount of liquid. Typically, the wipes are stacked and placed in the container and the liquid subsequently added thereto. The sheet can subsequently be used to wipe a surface as well as act as a vehicle to deliver and apply cleaning liquids to a surface. The moistened and/or saturated wipes can be used to treat various surfaces. As used herein “treating” surfaces is used in the broad sense and includes, but is not limited to, wiping, polishing, swabbing, cleaning, washing, disinfecting, scrubbing, scouring, sanitizing, and/or applying active agents thereto. The amount and composition of the liquid added to the cleaning sheets will vary with the desired application and/or function of the wipes. As used herein the term “liquid” includes, but is not limited to, solutions, emulsions, suspensions and so forth. Thus, liquids may comprise and/or contain one or more of the following: disinfectants; antiseptics; diluents; surfactants, such as nonionic, anionic, cationic, waxes; antimicrobial agents; sterilants; sporicides; germicides; bactericides; fungicides; virucides; protozoacides; algicides; bacteriostats; fungistats; virustats; sanitizers; antibiotics; pesticides; and so forth. Numerous cleaning compositions and compounds are known in the art and can be used in connection with the present invention. The liquid may also contain lotions and/or medicaments. The pre-moistened wipes of the present invention can be used for baby wipes, hand wipes, face wipes, cosmetic wipes, household wipes, industrial wipes and the like.

The amount of liquid contained within each pre-moistened wipe may vary depending upon the type of material being used to provide the pre-moistened wipe, the type of liquid being used, the type of container being used to store the wet wipes, and the desired end use of the wet wipe. Generally, each pre-moistened cleaning sheet can contain from about 150 to about 900 weight percent, depending on the end use. For example, for a low lint countertop or glass wipe a saturation level of about 150 to about 650 weight percent is desirable. For a pre-saturated mop application, the saturation level is desirably from about 500 to about 900 weight percent liquid based on the dry weight of the cleaning sheet, preferably about 650 to about 800 weight percent. If the amount of liquid is less than the above-identified ranges, the cleaning sheet may be too dry and may not adequately perform. If the amount of liquid is greater than the above-identified ranges, the cleaning sheet may be oversaturated and soggy and the liquid may pool in the bottom of the container.

### EXAMPLES

Several different laminates were prepared within the scope of the present invention. The layer having a mean equivalent pore radius of less than 100 μm in each of the following examples is a 20 gsm coform nonwoven web having about 65% by weight pulp fibers and about 35% by weight polymer fibers. This layer can be prepared in accordance with U.S. Pat. No. 4,100,324 to Anderson. To this layer, the following layer having a mean equivalent diameter greater than 100 μm.

1. A meltblown nonwoven web having a fiber diameter in the range on 20-60 μm, prepared from polypropylene and having a basis weight of about 34 gsm.

2. A bicomponent spunbond nonwoven web with a basis weight of about 20 gsm having filaments with an average denier of 5.0 dpf which are from a polyethylene component and a polypropylene component in a side-by-side configuration. This nonwoven web can be prepared in accordance with U.S. Pat. No. 5,382,400 to Pike and is point bonded with a H&P bond pattern.

3. A bicomponent spunbond nonwoven web with a basis weight of about 30 gsm having filaments with an average denier of 3.2 dpf which are from a polyethylene component and a polypropylene component in a side-by-side configuration. This nonwoven web can be prepared in accordance with U.S. Pat. No. 5,382,400 to Pike and through air bonded.

4. A spunbond nonwoven web having a basis weight of 34 gsm prepared from polypropylene. The spunbond nonwoven web is bond with an EHP bond pattern and is then creped to a crepe level of about 40%. The creping is accomplished by the method described in U.S. Pat. No. 6,150,002 to Varona.

5. A spunbond nonwoven web having a basis weight of 30 gsm prepared from polypropylene. The spunbond nonwoven web is bond with a wire weave bond pattern and is then creped to a crepe level of about 20%. The creping is accomplished by the method described in U.S. Pat. No. 6,150,002 to Varona.

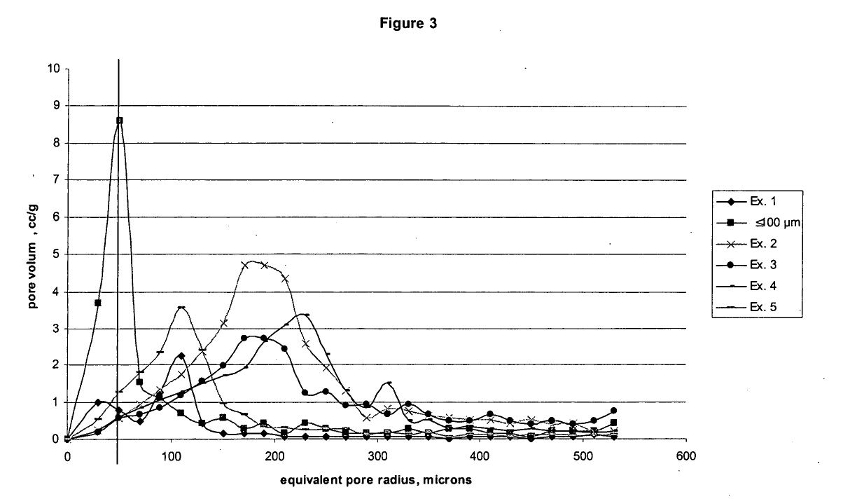

The pore size distribution for the laminate is show in FIG. 3. As can be seen, each sample has a bi-modal pore size distribution, resulting in wipers with superior cleaning ability, including properties of solution release and particle containment.

While the invention has been described in detail with respect to specific embodiments thereof, and particularly by the example described herein, it will be apparent to those skilled in the art that various alterations, modifications and other changes may be made without departing from the spirit and scope of the present invention. It is therefore intended that all such modifications, alterations and other changes be encompassed by the claims.

1. A nonwoven web laminate comprising a first nonwoven web layer comprising pores, and a second nonwoven web layer comprising pores, wherein the mean equivalent pore radius of the first nonwoven web layer is greater than about 100 μm, and the mean equivalent pore radius of the second nonwoven web layer is less than about 100 μm and the laminate has an overall pore size distribution which is at least bimodal.

2. The nonwoven web laminate of claim 1, wherein the first nonwoven web layer has a mean equivalent pore radius between about 100 μm and about 600 μm.

3. The nonwoven web laminate of claim 1, wherein the first nonwoven web layer comprises a creped nonwoven web, a nonwoven webs having fibers having a denier in excess of about 20 μm, a nonwoven web comprising crimped fibers, or a nonwoven web having high bond-to-bond distances.

4. The nonwoven web laminate of claim 1, wherein the nonwoven web of the first layer comprises a spunbond nonwoven web or a bonded carded nonwoven web.

5. The nonwoven web laminate of claim 4, wherein the nonwoven web of the first layer comprises a spunbond nonwoven web or a bonded carded nonwoven web.

6. The nonwoven web laminate of claim 5, wherein the nonwoven web of the first layer comprises crimped fibers.

7. The nonwoven web laminate of claim 5, wherein the nonwoven web of the first layer comprises a creped nonwoven web.

8. The nonwoven web laminate of claim 1, wherein the nonwoven web of the second layer has a mean equivalent pore radius between about 5 μm and about 100 μm.

9. The nonwoven web laminate of claim 1, wherein the nonwoven web of the second layer comprises a coform nonwoven web, an airlaid nonwoven webs, or a hydroentangled nonwoven web.

10. The nonwoven web laminate of claim 9, wherein the nonwoven web of the second layer comprises a coform nonwoven web.

11. The nonwoven web laminate of claim 1, further comprising a third nonwoven web layer, said third nonwoven web layer is adjacent to a side of the second nonwoven web layer which is opposite of a side of the second layer which is adjacent to the first layer, wherein the third layer has a mean equivalent pore radius greater than about 100 μm.

12. The nonwoven web laminate of claim 4, wherein the third layer has a mean equivalent pore radius between about 100 μm and about 600 μm.

13. The nonwoven web laminate of claim 1, further comprising a third layer, said third layer is adjacent to a side of the first layer and which is opposite of a side of the first layer which is adjacent to the second layer, wherein the third layer has a mean equivalent pore radius less than about 100 μm.

14. The nonwoven web laminate of claim 6, wherein the third layer has a mean equivalent pore radius between about 5 μm and about 100 μm.

15. The nonwoven web laminate of claim 13, wherein the nonwoven web of the first layer comprises a creped nonwoven web, a nonwoven web having fibers having a diameter in excess of about 20 μm, a nonwoven web comprising crimped fibers, or a nonwoven web having high bond-to-bond distances, the nonwoven web of the second and third layer comprises each individually comprises a coform nonwoven web, an airlaid nonwoven webs, or a hydroentangled nonwoven web.

16. The nonwoven web of claim 15, wherein the nonwoven web of the first layer has a mean equivalent pore radius between about 100 μm and about 600 μm, the nonwoven web of the second and third layers each comprise a coform nonwoven web having a equivalent pore radius between about 5 μm and about 100 μm.

17. A wipe comprising the nonwoven web laminate according to claim 1.

18. A wipe comprising the nonwoven web laminate according to claim 11.

19. A wipe comprising the nonwoven web laminate according to claim 13.

20. A wipe comprising the nonwoven web laminate according to claim 16.

21. A premoistened wipe comprising the nonwoven web laminate according to claim 1 and a fluid.

22. A premoistened wipe comprising the nonwoven web laminate according to claim 13 and a fluid.

23. A premoistened wipe comprising the nonwoven web laminate according to claim 16 and a fluid.
